(19) United States
(12) Patent Application Publication
(10) Pub. No.: US 2023/0397239 A1
(43) Pub. Date: Dec. 7, 2023

(54) CO-CHANNEL OR ADJACENT CHANNEL CO-EXISTENCE

(71) Applicant: QUALCOMM Incorporated, San Diego, CA (US)

(72) Inventors: Muhammad Sayed Khairy ABDELGHAFFAR, San Jose, CA (US); Krishna Kiran MUKKAVILLI, San Diego, CA (US); Marco PAPALEO, Bologna (IT); Yeliz TOKGOZ, San Diego, CA (US); Alexandros MANOLAKOS, Escondido, CA (US)

(21) Appl. No.: 18/252,677

(22) PCT Filed: Jan. 10, 2022
(86) PCT No.: PCT/US2022/070114

§ 371 Date: May 11, 2023

(30) Foreign Application Priority Data
Jan. 12, 2021 (GR) 20210100021

(51) Int. Cl. H04W 72/541; H04W 72/0446

(52) U.S. Cl. CPC H04W 72/541; H04W 72/0446

(57) ABSTRACT

Certain aspects are directed to a method for wireless communication by a first base station. The method generally includes: assessing expected interference from a second base station to uplink communications on at least a portion of a first slot, the at least the portion of the first slot being configured for downlink; determining whether to convert the configuration of the at least the portion of the first slot from the downlink to uplink based on the assessment of the expected interference; and receiving signaling from a user-equipment (UE) via the at least the portion of the first slot in accordance with the determination.

### CROSS-REFERENCE TO RELATED APPLICATION(S)

This application claims benefit of and priority to Greece Patent Application No. 20210100021, filed Jan. 12, 2021 which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for interference management.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

As the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include improved interference management.

Certain aspects are directed to a method for wireless communication by a first base station (BS). The method generally includes: assessing expected interference from a second base station (BS) to uplink communications on at least a portion of a first slot, the at least the portion of the first slot being configured for downlink; determining whether to convert the configuration of the at least the portion of the first slot from the downlink to uplink based on the assessment of the expected interference; and receiving signaling from a user equipment (UE) via the at least the portion of the first slot in accordance with the determination.

Certain aspects are directed to a method for wireless communication by a UE. The method generally includes: receiving, from a BS, an indication to report results of one or more measurements on at least a portion of a first slot associated with at least the portion of a second slot configured for downlink; reporting the results of the one or more measurements to the BS; receiving, from the BS, an indication that the configuration of the at least the portion of the second slot is to be converted from the downlink to uplink based on the reporting of the results of the one or more measurements; and transmitting signaling to the BS via the at least the portion of the second slot in accordance with the indication that the at least the portion of the second slot is to be converted.

Certain aspects are directed to an apparatus for wireless communication by a first BS. The apparatus generally includes a memory, and one or more processors coupled to the memory, the memory and the one or more processors being configured to: assess expected interference from a second BS to uplink communications on at least a portion of a first slot, the at least the portion of the first slot being configured for downlink; determine whether to convert the configuration of the at least the portion of the first slot from the downlink to uplink based on the assessment of the expected interference; and receive signaling from a UE via the at least the portion of the first slot in accordance with the determination.

Certain aspects are directed to an apparatus for wireless communication by a UE. The apparatus generally includes a memory, and one or more processors coupled to the memory, the memory and the one or more processors being configured to: receive, from a BS, an indication to report results of one or more measurements on at least a portion of a first slot associated with at least the portion of a second slot configured for downlink; report the results of the one or more measurements to the BS; receive, from the BS, an indication that the configuration of the at least the portion of the second slot is to be converted from the downlink to uplink based on the reporting of the results of the one or more measurements; and transmit signaling to the BS via the at least the portion of the second slot in accordance with the indication that the at least the portion of the second slot is to be converted.

Certain aspects are directed to an apparatus for wireless communication by a first BS. The apparatus generally includes means for assessing expected interference from a second BS to uplink communications on at least a portion of a first slot, the at least the portion of the first slot being configured for downlink; means for determining whether to convert the configuration of the at least the portion of the first slot from the downlink to uplink based on the assessment of the expected interference; and means for receiving signaling from a UE via the at least the portion of the first slot in accordance with the determination.

Certain aspects are directed to an apparatus for wireless communication by a UE. The apparatus generally includes means for receiving, from a BS, an indication to report results of one or more measurements on at least a portion of a first slot associated with at least the portion of a second slot configured for downlink; means for reporting the results of the one or more measurements to the BS; means for receiving, from the BS, an indication that the configuration of the at least the portion of the second slot is to be converted from the downlink to uplink based on the reporting of the results of the one or more measurements; and means for transmitting signaling to the BS via the at least the portion of the second slot in accordance with the indication that the at least the portion of the second slot is to be converted.

Certain aspects are directed to a non-transitory computer-readable medium having instructions stored thereon to cause a first BS to: assess expected interference from a second BS to uplink communications on at least a portion of a first slot, the at least the portion of the first slot being configured for downlink; determine whether to convert the configuration of the at least the portion of the first slot from the downlink to uplink based on the assessment of the expected interference; and receive signaling from a UE via the at least the portion of the first slot in accordance with the determination.

Certain aspects are directed to a non-transitory computer-readable medium having instructions stored thereon to cause a UE to: receive, from a BS, an indication to report results of one or more measurements on at least a portion of a first slot associated with at least the portion of a second slot configured for downlink; report the results of the one or more measurements to the BS; receive, from the BS, an indication that the configuration of the at least the portion of the second slot is to be converted from the downlink to uplink based on the reporting of the results of the one or more measurements; and transmit signaling to the BS via the at least the portion of the second slot in accordance with the indication that the at least the portion of the second slot is to be converted.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure, and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and an example user equipment (UE), in accordance with certain aspects of the present disclosure.

FIG. 3 is an example frame format for certain wireless communication systems (e.g., new radio (NR)), in accordance with certain aspects of the present disclosure.

FIGS. 4A and 4B illustrates two networks associated with different operators implemented across a border, in accordance with certain aspects of the present disclosure.

FIG. 5 illustrates a default frame structure, in accordance with certain aspects of the present disclosure.

FIG. 6A illustrates a frame structure for semi-synchronous operation, in accordance with certain aspects of the present disclosure.

FIG. 6B illustrates a frame structure for semi-synchronous operation of two operators, in accordance with certain aspects of the present disclosure.

FIG. 7 illustrates conversion of a downlink (DL) slot to an uplink (UL) slot, in accordance with certain aspects of the present disclosure.

FIG. 8 is a flow diagram illustrating example operations for wireless communication by a BS, in accordance with certain aspects of the present disclosure.

FIG. 9 is a diagram illustrating granularity associated with slot conversion from DL to UL, in accordance with certain aspects of the present disclosure.

FIG. 10 is a diagram illustrating sensing by a BS to determine whether to convert one or more DL slots to UL slots, in accordance with certain aspects of the present disclosure.

FIG. 11 is a call flow diagram illustrating example operations for conversion of a slot based on UE measurements, in accordance with certain aspects of the present disclosure.

FIG. 12 is a flow diagram illustrating example operations for wireless communication by a UE, in accordance with certain aspects of the present disclosure.

FIG. 13 is a diagram illustrating the conversion of a slot from half-duplex to full-duplex (FD), in accordance with certain aspects of the present disclosure.

FIG. 14 is a diagram illustrating the conversion from DL to UL of a subband of a component carrier (CC), in accordance with certain aspects of the present disclosure.

FIG. 15 illustrates a communications device that may include various components configured to perform operations for the techniques disclosed herein in accordance with aspects of the present disclosure.

FIG. 16 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for assessing interference to convert at least a portion of a slot configured for downlink (DL) to uplink (UL). For example, relatively lower interference may be experienced between links of base stations (BSs) when the BSs are synchronized to both perform DL or UL at a given point in time. In some aspects, a BS may determine to opportunistically convert at least a portion of a DL slot to an UL slot by first performing an assessment of expected interference if the conversion occurs. For example, the BS may sense the medium to determine how much interference is to be expected if the portion of the slot is converted to UL, or configure one or more UEs to perform and report measurements that allow the BS to determine whether to convert a DL slot to an UL slot (or full-duplex slot). In some aspects, the BS may receive an indication of a slot pattern of one or more neighboring BSs, allowing the BS to determine whether the conversion of a slot should occur, as described in more detail herein.

The following description provides examples of interference management in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTIs) to meet respective quality of service (QoS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations frequency range 1 (FR1) (410 megahertz (MHz)-7.125 gigahertz (GHz)) and frequency range 2 (FR2) (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. Multiple-input multiple-output (MIMO) transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Example Wireless Communication Network

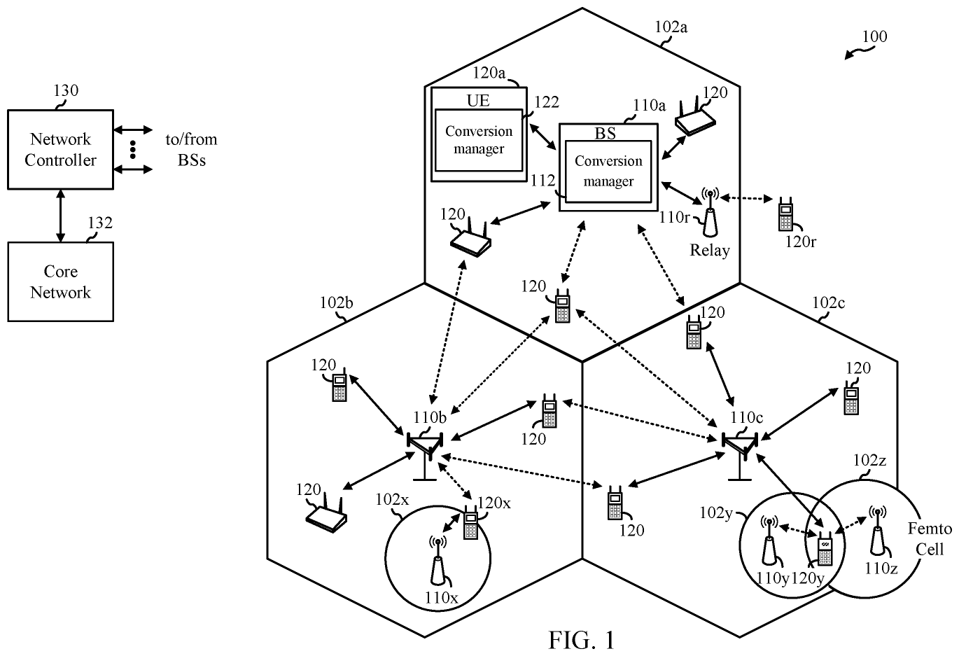

FIG. 1 illustrates an example wireless communication network 100 in which aspects of the present disclosure may be performed. For example, wireless communication network 100 may include one or more base station (BSs) 110a-z (each also individually referred to herein as BS 110 or collectively as BSs 110) and/or user equipments (UEs) 120a-y (each also individually referred to herein as UE 120 or collectively as UEs 120). According to certain aspects, the BSs 110 and UEs 120 may be configured for slot conversion from downlink (DL) to uplink (UL). As shown in FIG. 1, BS 110a includes a conversion manager 112 that may assess expected interference on at least a portion of a slot and determine whether to convert the at least the portion of the slot from DL to UL based on the assessment, in accordance with certain aspects of the present disclosure. Similarly, UE 120a includes a conversion manager 122 that may report results of one or more measurements to facilitate conversion of at least a portion of a slot from DL to UL, in accordance with certain aspects of the present disclosure.

Wireless communication network 100 may be a New Radio (NR) system (e.g., a 5G NR network). As shown in FIG. 1, wireless communication network 100 may be in communication with a core network 132. The core network 132 may be in communication with the one or more BSs and/or UEs in wireless communication network 100 via one or more interfaces.

A BS 110 may provide communication coverage for a particular geographic area, sometimes referred to as a “cell”, which may be stationary or may move according to the location of a mobile BS 110. In some examples, BSs 110 may be interconnected to one another and/or to one or more other BSs 110 or network nodes (not shown) in wireless communication network 100 through various types of backhaul interfaces (e.g., a direct physical connection, a wireless connection, a virtual network, or the like) using any suitable transport network. In the example shown in FIG. 1, BSs 110a, 110b and 110c may be macro BSs for the macro cells 102a, 102b and 102c, respectively. BS 110x may be a pico BS for a pico cell 102x. BSs 110y and 110z may be femto BSs for the femto cells 102y and 102z, respectively. A BS 110 may support one or multiple cells.

BSs 110 communicate with UEs 120 in the wireless communication network 100. UEs 120 (e.g., 120x, 120y, etc.) may be dispersed throughout wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

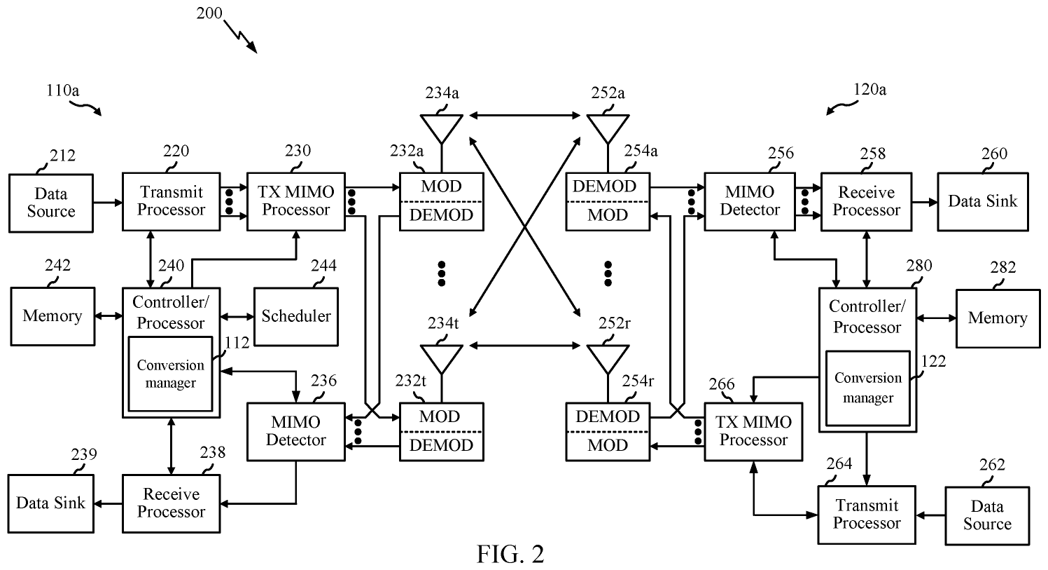

FIG. 2 illustrates example components of BS 110a and UE 120a (e.g., wireless communication network 100 of FIG. 1), which may be used to implement aspects of the present disclosure.

At BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each modulator may further process (e.g., convert to analog, amplify, filter, and upconvert) the output sample stream to obtain a downlink signal. DL signals from the modulators in transceivers 232a-232t may be transmitted via the antennas 234a-234t, respectively.

At UE 120a, antennas 252a-252r may receive the DL signals from BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for UE 120a to a data sink 260, and provide decoded control information to a controller/processor 280.

On the UL, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (RS) (e.g., for the sounding reference signal (SRS)). The symbols from transmit processor 264 may be precoded by a TX MIMO processor 266 if applicable, further processed by the modulators in transceivers 254a-254r (e.g., for single-carrier frequency division multiplexing (SC-FDM), etc.), and transmitted to BS 110a. At BS 110a, the UL signals from UE 120a may be received by antennas 234, processed by demodulators in transceivers 232a-232t, detected by MIMO detector 236 if applicable, and further processed by receive processor 238 to obtain decoded data and control information sent by UE 120a. Receive processor 238 may provide the decoded data to a data sink 239 and the decoded control information to controller/processor 240.

Memories 242 and 282 may store data and program codes for BS 110a and UE 120a, respectively. A scheduler 244 may schedule UEs for data transmission on the DL and/or UL.

Antennas 252, processors 266, 258, 264, and/or controller/processor 280 of UE 120a and/or antennas 234, processors 220, 230, 238, and/or controller/processor 240 of BS 110a may be used to perform the various techniques and methods described herein. For example, as shown in FIG. 2, controller/processor 240 of BS 110a includes a conversion manager 112 that may assess expected interference on at least a portion of a slot and determine whether to convert the at least the portion of the slot from DL to UL based on the assessment, in accordance with certain aspects described herein. Similarly, as shown in FIG. 2, controller/processor 280 of UE 120a includes a conversion manager 122 that may report results of one or more measurements to facilitate conversion of at least a portion of a slot from DL to UL, in accordance with certain aspects described herein. Although shown at the controller/processor, other components of UE 120a and BS 110a may be used to perform the operations described herein.

NR may utilize OFDM with a cyclic prefix (CP) on the UL and DL. NR may support half-duplex operation using time division duplexing (TDD). OFDM and SC-FDM partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kilohertz (KHz) and other SCS may be defined with respect to the base SCS (e.g., 30 kHz, 60 kHz, 120 kHz, 240 kHz, etc.).

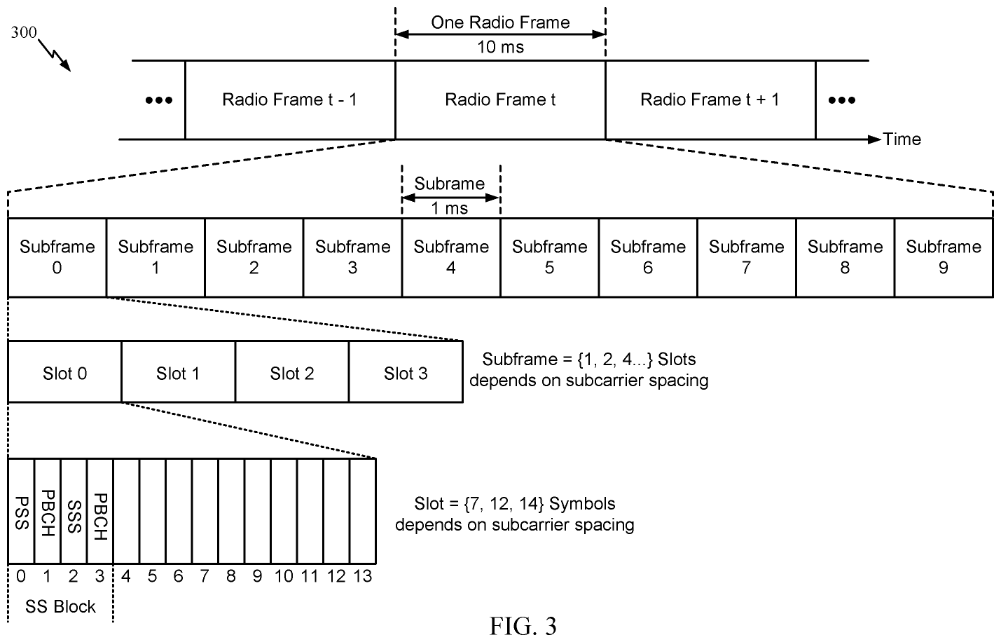

FIG. 3 is a diagram showing an example of a frame format 300 for NR. The transmission timeline for each of the DL and UL may be partitioned into units of radio frames. Each radio frame may have a predetermined duration (e.g., 10 milliseconds (ms)) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval (TTI) having a duration less than a slot (e.g., 2, 3, or 4 symbols). Each symbol in a slot may be configured for a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, and the SSS may provide the CP length and frame timing. The PSS and SSS may provide the cell identity. The PBCH carries some basic system information, such as DL system bandwidth, timing information within radio frame, synchronization signal (SS) burst set periodicity, system frame number, etc. The SSBs may be organized into SS bursts to support beam sweeping. Further system information such as, remaining minimum system information (RMSI), system information blocks (SIBs), other system information (OSI) can be transmitted on a PDSCH in certain subframes. The SSB can be transmitted up to sixty-four times, for example, with up to sixty-four different beam directions for mmWave. The multiple transmissions of the SSB are referred to as an SS burst set. SSBs in an SS burst set may be transmitted in the same frequency region, while SSBs in different SS bursts sets can be transmitted at different frequency regions.

### Example Techniques for Co-Channel or Adjacent Channel Co-Existence

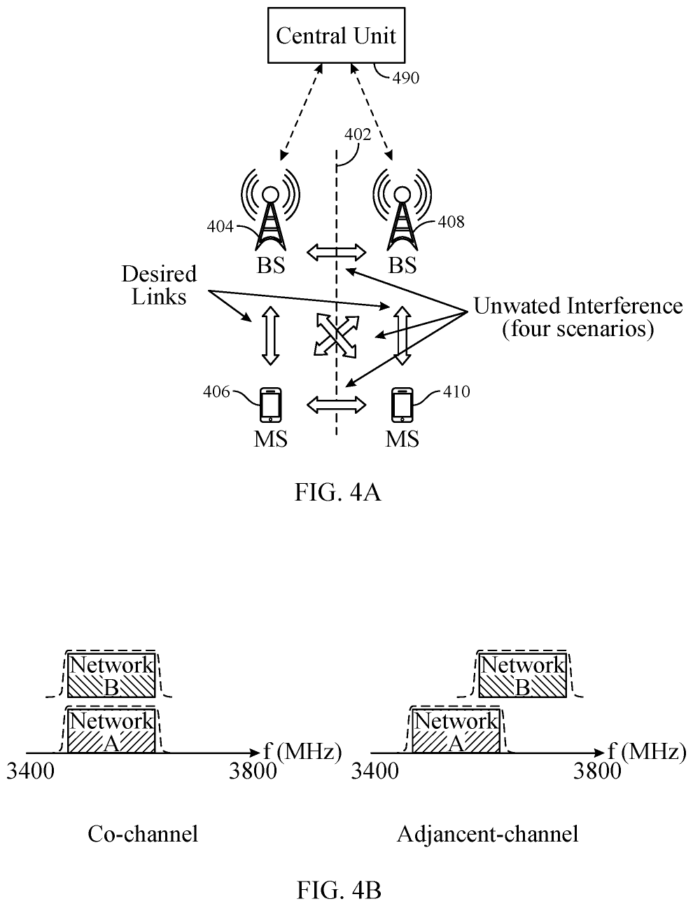

Certain aspects of the present disclosure are generally directed to efficient usage of a spectrum which may be implemented at a cross border (e.g. a country border). The networks at the cross border may be managed by an organization such as the European Conference of Postal and Telecommunications Administrations (CEPT). Time-division duplex (TDD) networks may be implemented in a frequency band, such as 3400-3800 megahertz (MHz). These TDD networks may cause cross-link interference between different networks of different operators, as described in more detail with respect to FIGS. 4A and 4B.

Certain aspects of the present disclosure may be applicable for efficient spectrum utilization across gNBs that adopt different duplexing pattern (e.g. a first gNB deploying a legacy TDD and a second gNB is deploying a full duplex with simultaneous UL and DL at a same resource). The two gNBs may belong to the same operator or different operators.

FIGS. 4A and 4B illustrate two networks associated with different operators implemented across a border 402 (e.g., a cross border). As illustrated, a base station (BS) 404 (e.g., such as BS 110a illustrated in FIGS. 1 and 2) and a UE 406 (e.g., mobile station (MS)) (e.g., such as UE 120a illustrated in FIGS. 1 and 2) may be associated with a network of a first operator, and the BS 408 and UE 410 may be associated with a network of a second operator. BSs 404, 408 and UEs 406, 410 may cause interference to the desired links of each network. Different interference scenarios may occur when two TDD networks are deployed in blocks within the same band or adjacent bands (including co-channel interference and adjacent channel interference, as illustrated in FIG. 4B). For example, there may be four interference scenarios including interference between BS 404 and BS 408, interference between UE 406 and UE 410, interference between BS 404 and UE 410, and/or interference between BS 408 and UE 406. In certain aspects, BSs 404, 408 may be in communication with a central unit 490, as illustrated.

As illustrated in FIG. 4B, the interference between the links may be co-channel interference or adjacent channel interference. Co-channel interference occurs when two links of different networks (e.g., network A and network B) are configured on the same band (e.g., on the same frequency channel), and adjacent channel interference occurs when the links are configured on adjacent bands, yet still interfere due to adjacent channel leakage ratio (ACLR) of the links. ACLR is used as a measure of the amount of power leaking into adjacent channels and is defined as the ratio of the filtered mean power centered on the assigned channel frequency to the filtered mean power centered on an adjacent channel frequency.

Cross link interference may occur when simultaneous transmissions in uplink (UL) and downlink (DL) directions take place in different TDD networks. For example, for synchronous operation, two different links may be synchronized such that both networks are performing only DL or only UL at any point in time. In other words, simultaneous UL and DL transmissions do not take place in cases of synchronized operation, but do take place in cases of unsynchronized and desynchronized operation (interchangeably referred to herein as “asynchronous operation”), as described in more detail herein.

For synchronous operation, simultaneous UL/DL transmissions do not occur. At any given moment in time, either all synchronized networks transmit in DL or all synchronized networks transmit in UL. This helps avoid interference between the transmission of one BS and the reception of another BS in the same or an adjacent network since both BSs are either transmitting or receiving. To implement synchronous operation, a common frame structure with time and phase synchronization may be configured between networks. On the other hand, asynchronous operation may not require the adoption of a compatible frame structure between networks. Each network may be in a UL mode or a DL mode without considering other networks, which may result in interference.

For semi-synchronous operation, a portion of a frame may be consistent with synchronized operation as described, while the remaining portion of the frame may be consistent with unsynchronized operation. In other words, some slots of the frame may be designated for only DL or only UL among the networks, while some slots may be flexible slots that can be configured for DL or UL at the discretion of the associated BS. This leads to a limited degree of frame structure flexibility at the expense of some additional interference, and still requires the adoption of a frame structure for all TDD networks involved, including slots where the UL/DL direction is not specified. For semi-synchronous operation, the control plane may be protected by ensuring that control signals are not configured on the flexible part of the frame.

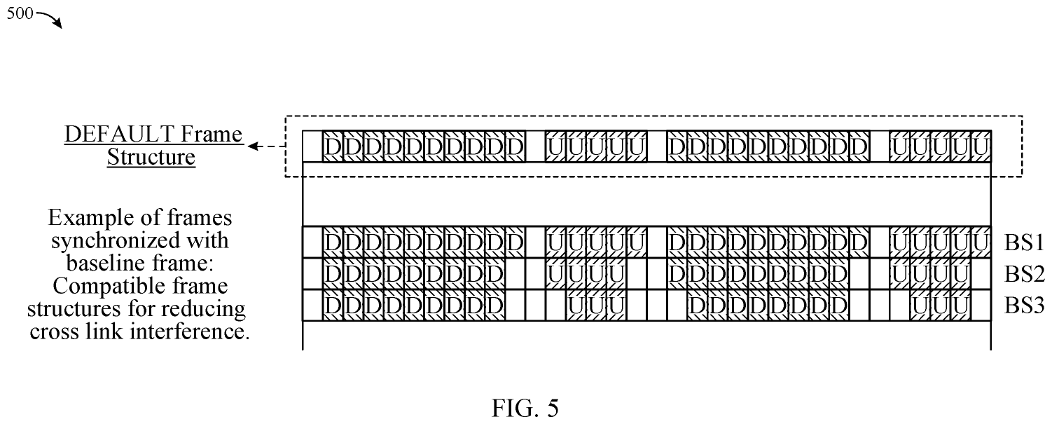

FIG. 5 illustrates a default frame structure 500, in accordance with certain aspects of the present disclosure. As illustrated in FIG. 5, some slots of a frame may be designated for DL (labeled “D” in frame structure 500), and some slots of the frame may be designated for UL (labeled “U” in frame structure 500). As illustrated, the configured frame structure for each of BS1, BS2, and BS3 may follow the default frame structure. As illustrated, BS2 and BS3 may determine to not communicate on some of the DL or UL slots, but may not convert any slots that are designated for DL to UL or designated for UL to DL.

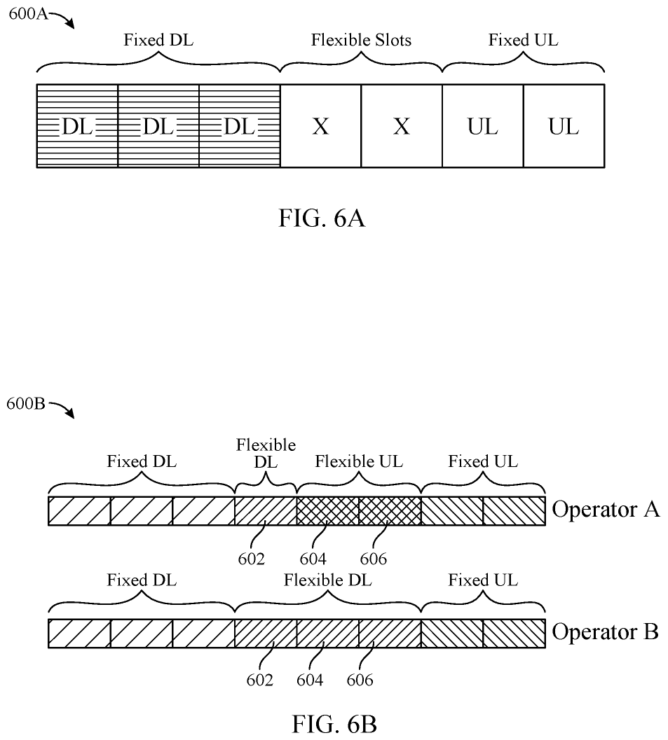

FIG. 6A illustrates a frame structure 600A for semi-synchronous operation, in accordance with certain aspects of the present disclosure. As illustrated in FIG. 6A, some slots of frame structure 600A are designated for DL (labeled “DL” in FIG. 6A, also referred to as “fixed DL”), some slots of frame structure 600 are designated for UL (labeled “UL” in FIG. 6A, also referred to as “fixed UL”), and some slots of frame structure 600 are designated as flexible slots (labeled “X” in FIG. 6A). Networks configured with frame structure 600 may configure the flexible slots with either DL, UL, or both DL and UL.

FIG. 6B illustrates a frame structure 600B for semi-synchronous operation of two operators, in accordance with certain aspects of the present disclosure. A frame structure may also be referred to herein as a slot format pattern. A slot format pattern may be semi-statically configured per BS.

As illustrated, some slots of frame structure 600B are designated for DL (labeled “DL” in FIG. 6B), some slots of frame structure 600B are designated for UL (labeled “UL” in FIG. 6B), and some slots of frame structure 600B are designated as flexible slots (labeled “X” in FIG. 6B). Networks configured with frame structure 600B may configure the flexible slots with either DL, UL, or both DL and UL, as described with respect to FIG. 6A. For example, slots 602, 604 606 may be flexible slots, and slot 602 may be configured for DL, slot 604 may be configured for UL, and slot 606 may be configured for UL by operator A. On the other hand, operator B may configure slots 602, 604, 606 as all DL slots. Thus, the likelihood of interference between links of the operators is greater in slots 604, 606, as compared to slot 602, because the BS of operator A is receiving (e.g., UL transmissions) in slots 604, 606 while the BS of operations B is transmitting (e.g., DL transmissions) in slots 604, 606.

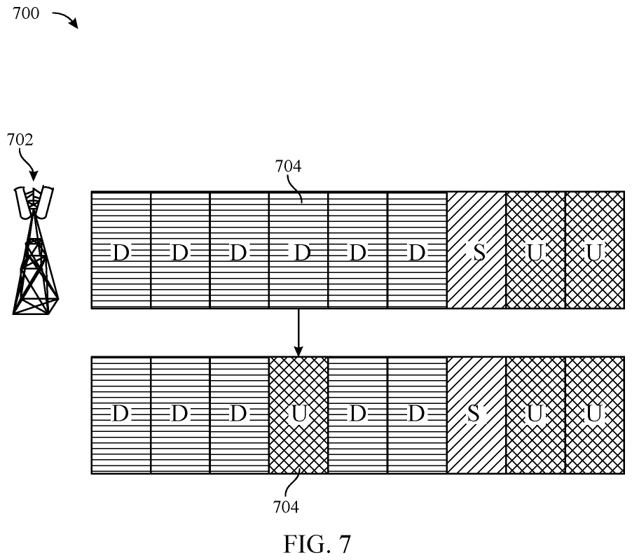

FIG. 7 illustrates the conversion 700 of a DL slot to a UL slot, in accordance with certain aspects of the present disclosure. For example, a BS 702 may opportunistically convert a slot 704 configured for DL to UL. During slots configured using an asynchronous scheme or during flexible slots configured using a semi-synchronous scheme, different BSs may use the same or different traffic directions, and hence there may be no interference or high jamming (e.g., disruption of existing wireless communications by decreasing the SNR through the transmission of interfering wireless signals) between the BSs accordingly. For a BS to receive UL reliably (e.g., for ultra-reliable low-latency communication (URLLC) use cases), the BS may use either (1) a dedicated UL slot (e.g., of a semi-synchronous scheme) which may suffer from long latency or (2) UL slots with possible interference from other operators (e.g., cross border operators, as described with respect to FIGS. 4A and 4B). In certain aspects of the present disclosure, a BS may opportunistically convert some DL slots (e.g., slot 704) into UL to receive data/control from UEs reliably.

In certain aspects, at a cross-border, operators may sense a spectrum for a few slots assuming different hypotheses of frame formats of other operators to determine whether to convert a slot from DL to UL. For example, if there is no jamming (or interference is less than a threshold) for one or more slots, a corresponding BS may convert a DL slot to an UL slot, as described in more detail herein. In certain aspects, the operators may decode, from broadcast signals, the frame formats of other operators, based on which the operators can decide whether to convert a slot from DL to UL. In some cases, the operators may listen (e.g., sense) the spectrum, and with the assistance of decoded broadcast messages indicating the frame formats of other operators, determine whether to convert a DL slot to an UL slot.

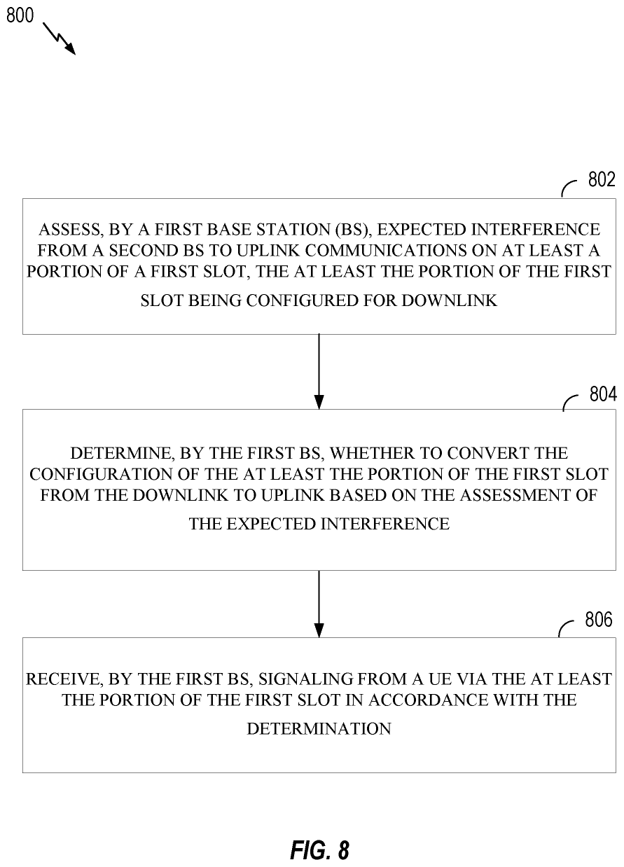

FIG. 8 is a flow diagram illustrating example operations 800 for wireless communication by a BS, in accordance with certain aspects of the present disclosure. Operations 800 may be performed, for example, by BS 404 described with respect to FIG. 4A (also BS 110a described with respect to FIGS. 1 and 2).

Operations 800 may be implemented as software components that are executed and run on one or more processors (e.g., controller/processor 240 of FIG. 2). Further, the transmission and reception of signals by the BS in operations 800 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

Operations 800 begin, at 802, by the first BS (e.g., BS 404 illustrated in FIG. 4A) assessing expected interference from a second BS (e.g., BS 408 illustrated in FIG. 4A) to UL communications on at least a portion of a first slot, the at least the portion of the first slot being configured for DL. The first BS and the second BS may be associated with different operators (e.g., inter-operators) or the same operators (e.g., intra-operator) (e.g., on the same frequency, one cell may be doing DL and one cell may be doing UL).

At 804, the first BS determines whether to convert the configuration of the at least the portion of the first slot from the DL to UL based on the assessment of the expected interference. At 806, the first BS receives signaling from a UE via the at least the portion of the first slot in accordance with the determination.

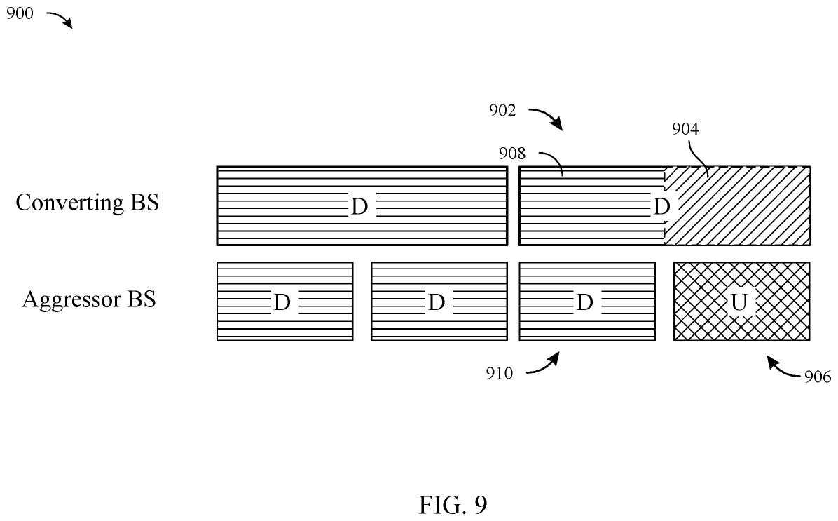

FIG. 9 is a diagram 900 illustrating granularity associated with slot conversion from DL to UL, in accordance with certain aspects of the present disclosure. As described herein, only a portion of a slot may be converted from DL to UL, in certain aspects. In other words, the granularity associated with the slot conversion may be a sub-slot (or mini-slot), such as a few symbols within a slot. For example, the subcarrier spacing (SCS) associated with slots of an aggressor BS (e.g., BS 408) and a converting BS (e.g., BS 404 determining to convert a DL slot to an UL slot) may be different. Thus, the length of slots configured for converting BS 404 may be longer than the slots configured for aggressor BS 408, as illustrated (or vice versa). Thus, BS 404 may only convert portion 904 of slot 902 to UL that is aligned (or overlap) in the time-domain with the UL slot 906 of aggressor BS 408, while keeping the other portion 908 of slot 902 configured for DL as it is aligned with the DL slot 910.

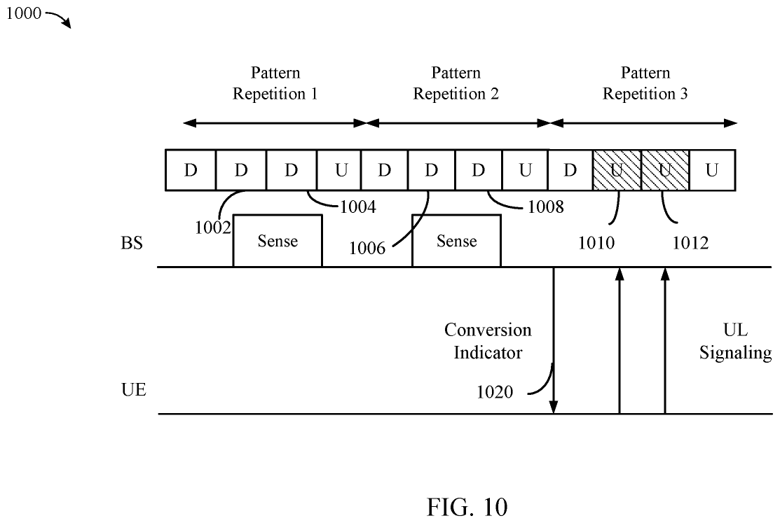

In certain aspects, the BS may assess the expected interference by performing channel sensing. For example, the BS may listen to (e.g., sense) at least a portion of a band of a slot and determine the direction of communications by other BSs to determine whether to convert a DL slot to an UL slot, as described in more detail with respect to FIG. 10.

FIG. 10 is a diagram 1000 illustrating sensing by a BS to determine whether to convert one or more DL slots to UL slots, in accordance with certain aspects of the present disclosure. As illustrated in FIG. 10, a particular slot format pattern (e.g., D slot, D slot, D slot, U slot) may repeat over multiple intervals. A BS (e.g., BS 404 illustrated in FIG. 4A) may sense the spectrum during one or more slots of the slot format pattern across one or more intervals. For example, the BS may perform sensing during slots 1002, 1004 during the first pattern repetition interval, and perform sensing on slots 1006, 1008 during the second pattern repetition interval. If the BS determines that the energy level sensed during the slots is less than a configured energy threshold, the BS may determine to convert the corresponding slots 1010, 1012 of the third pattern repetition interval, as illustrated. For example, the BS may transmit a conversion indicator 1020 (e.g., a slot format indicator (SFI)) to a UE (e.g., UE 406 illustrated in FIG. 4A) indicating that the slots 1010, 1012 are converted to UL, facilitating UL signaling during slots 1010, 1012, as illustrated. In other words, based on the sensing, the BS may identify the communication direction (e.g., UL or DL) of other networks during the sensed slots, and decide whether to convert DL slots to UL slots accordingly (e.g., for slots subsequent in time).

In certain aspects, the sensing may be beam-specific. For example, UL reception at the BS may be clear (e.g., experience low interference) in specific directions (beams). Thus, the BS may perform sensing on various suitable beams (e.g., beams 1-4), where only the energy level sensed on some of the beams (e.g., beam 2) is below the configured energy threshold. Thus, the BS may convert the DL slots to UL for one or more beams with sensed energy levels below the configured energy threshold (e.g., only beam 2).

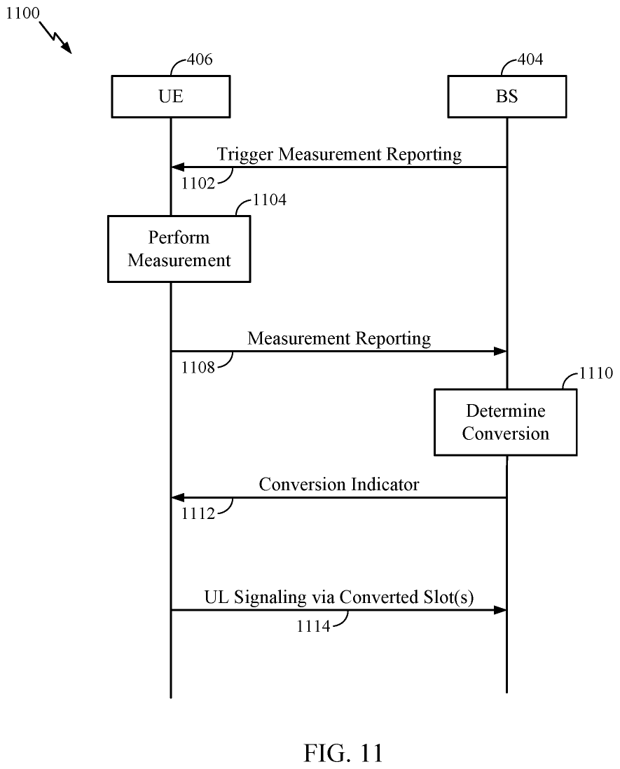

FIG. 11 is a call flow diagram 1100 illustrates example operations for the conversion of a slot based on UE measurements, in accordance with certain aspects of the present disclosure. A BS may configure some UEs to measure and report the energy sensed at specific slots with specific beam directions. For instance, the UE may be configured to report reference signal received power (RSRP) or signal-to-interference-plus-noise ratio (SINR) to the BS, allowing the BS to determine whether to convert a DL slot to an UL slot. As illustrated in FIG. 11, a BS 404 may transmit, to a UE 406, a trigger message 1102 that triggers measurement reporting. In response, UE 406 may perform measurements at block 1104. For example, UE 406 may perform measurements during slots 1002, 1004, as shown in FIG. 10. Subsequently, as shown in FIG. 11, UE 406 may transmit, to BS 404, a measurement report 1108 indicating the results of the measurements. Based on the results of the measurements, BS 404 may determine, at block 1110, whether to convert one or more DL slots to UL slots (e.g., slots 1010, 1012 of FIG. 10). BS 404 may then transmit a conversion indicator 1112 (e.g. corresponding to conversion indicator 1020 of FIG. 10) to UE 406, facilitating UL signaling 1114 via the converted slots.

In certain aspects, the assessment of the expected interference may be based on an indication from a central unit (e.g., central unit 490 illustrated in FIG. 4A) (e.g., intra-operator) to a BS (e.g., BS 404) that indicates whether an aggressor BS (e.g., BS 408) is configured to perform DL or UL during a slot to be converted (e.g., by BS 404). The indication from central unit 490 may be through layer-3 (L3) signaling. In other words, if BS 404 determines, based on the indication from central unit 490, that the communication directions of BS 404 and BS 408 will be in sync during a slot after conversion of the slot to UL, then BS 404 may perform the conversion of the slot.

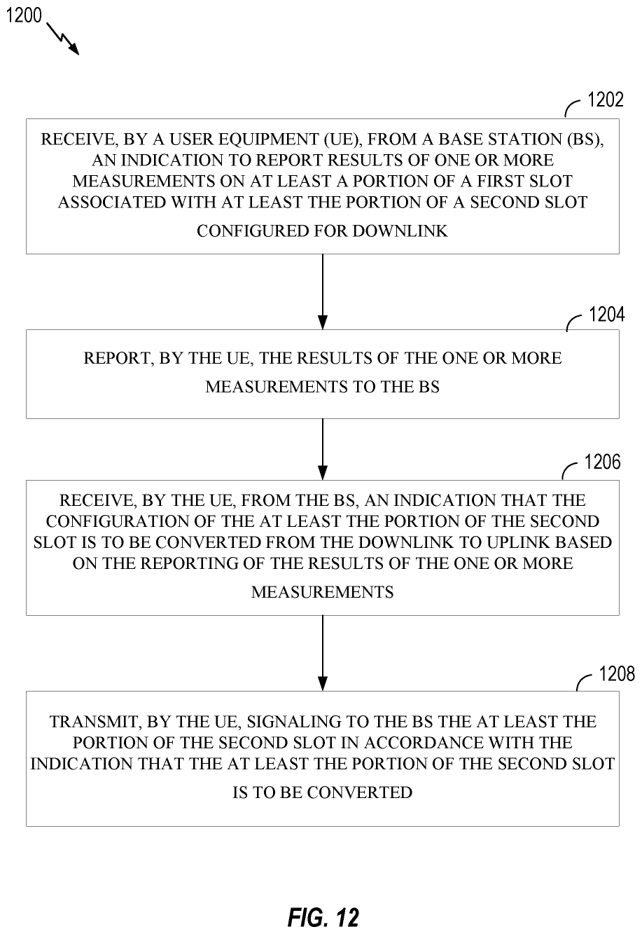

FIG. 12 is a flow diagram illustrating example operations 1200 for wireless communication by a UE, in accordance with certain aspects of the present disclosure. Operations 1200 may be performed, for example, by UE 120a in wireless communication network 100. Operations 1200 may be considered complementary to operations 800 of FIG. 8.

Operations 1200 may be implemented as software components that are executed and run on one or more processors (e.g., controller/processor 280 of FIG. 2). Further, the transmission and reception of signals by the UE in operations 1200 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

Operations 1200 may begin, at 1202, by the UE receiving, from a BS, an indication to report results of one or more measurements on at least a portion of a first slot associated with at least the portion of a second slot configured for DL. At 1204, the UE reports the results of the one or more measurements to the BS. At 1206, the UE receives, from the BS, an indication that the configuration of the at least the portion of the second slot is to be converted from the DL to UL based on the reporting of the results of the one or more measurements. At 1208, the UE transmits signaling to the BS via the at least the portion of the second slot in accordance with the indication that the at least the portion of the second slot is to be converted.

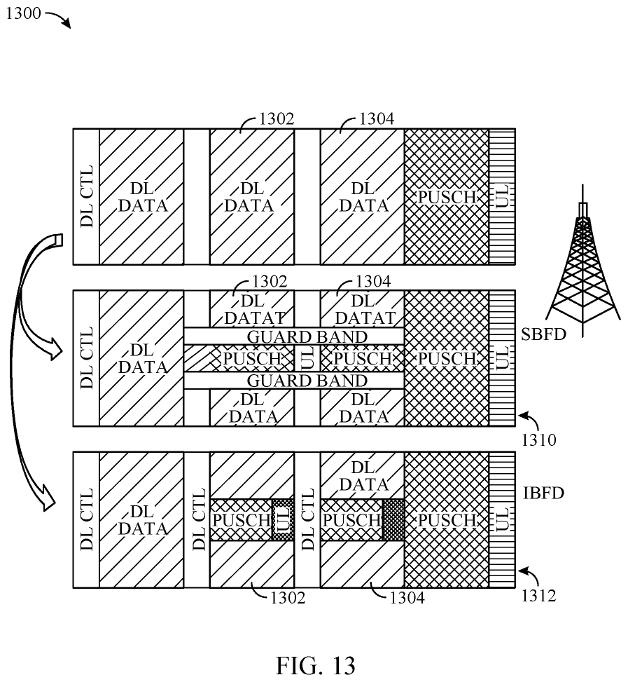

FIG. 13 is a diagram 1300 illustrating the conversion of a slot from half-duplex full-duplex (FD), in accordance with certain aspects of the present disclosure. For example, an FD capable BS (e.g., BS 404) may convert a legacy DL slot into an FD slot with simultaneous UL reception and DL transmission in the same frequency band (e.g., in-band FD (IBFD) (e.g., overlapping UL and DL subbands) or subband FD (SBFD)). As illustrated in FIG. 13, the slots 1302, 1304 may be converted from DL slots to SBFD slots as shown by slot configuration 1310, or converted to IBFD slots as shown by slot configuration 1312. As illustrated by configurations 1310, a subband (e.g., central portion) of the band of each of slots 1302, 1304 may be configured for UL (e.g., for physical uplink shared channel (PUSCH)), that may be separated from subbands allocated for DL by guard bands, (e.g., a narrow frequency range that separates two ranges of wider frequency and is used to help mitigate, or ensure, interference for simultaneous communication channels) as illustrated. As illustrated by configuration 1312 for IBFD, a central portion of the band of each of slots 1302, 1304 may be configured for UL (e.g., for PUSCH). Guard bands may not be used in configuration 1312.

As described herein, the BS may assess expected interference by performing sensing. In some aspects, a BS may sense the channel using a subset of antennas of a first antenna panel, or using a second antenna panel. When some slots experience jamming that is less than a threshold (e.g., from other operators either co-channel or adjacent channel or self-jamming), the BS may convert the slots from DL to UL. The determining of the level of jamming may be based on quality of service of the UL channel (e.g., UL SINR or UL RSRS) meeting certain thresholds. The BS may decide to convert the DL slot into SBFD (or IBFD) and initiate (e.g., transmit) a group common indicator (e.g., conversion indicator 1112 (SFI)) to the UE to indicate the new slot pattern. In certain aspects, the BS may indicate to other operators the change of slot format via an inter-BS link.

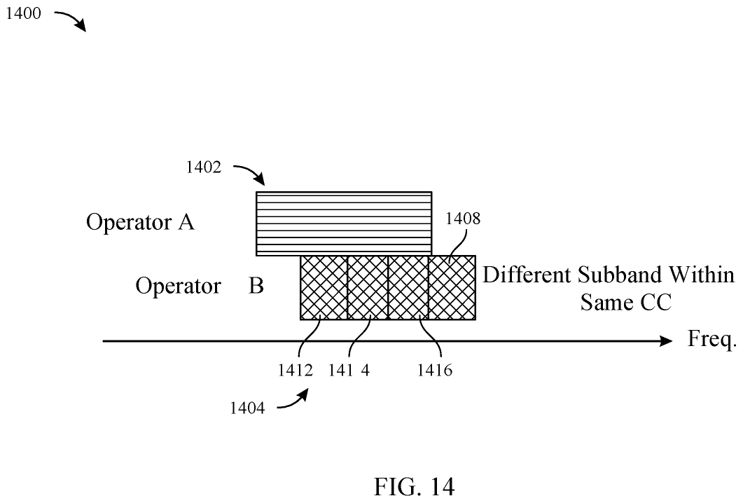

FIG. 14 is a diagram 1400 illustrating the conversion from DL to UL of a subband of a component carrier (CC), in accordance with certain aspects of the present disclosure. As illustrated, a slot for operator A may be within a CC 1402 and a slot for operator B may be within a CC 1404. As illustrated, subbands 1412, 1414, 1416 may overlap in the frequency domain with the CC 1402, and thus, may experience relatively higher interference as compared to subband 1408 which is non-overlapping in the frequency domain with the CC 1402. The BS for operator B may only convert subband 1408 from DL to UL. In other words, the BS may perform sensing (or configure a UE to perform measurements) on different subbands of the same CC (e.g., CC 1404). Reporting of subband measurement parameters (e.g., RSRP, reference signal strength indication (RSSI), SINR) enable transitioning a slot inside a CC to FD. In other words, subband level measurements or sensing may allow the BS to determine which part of the slot should be DL and which part should be UL. The BS may configure some UEs to measure and report the energy sensed at specific slots/symbols and specific subbands with specific beam directions (e.g., RSRP or SINR reporting), as described herein. The UE may report SINR, RSRP and RSSI on different subbands inside the same CC. This can be done on a DL slot or an UL slot. For a DL slot (on which reference signals (RSs) may be received), the UE may report parameters such as RSRP or SINR based on reference signals. On an UL slot, the UE may reporting parameters such as RSSI (e.g., an indication of a sensed energy level).

### Wireless Communications Devices

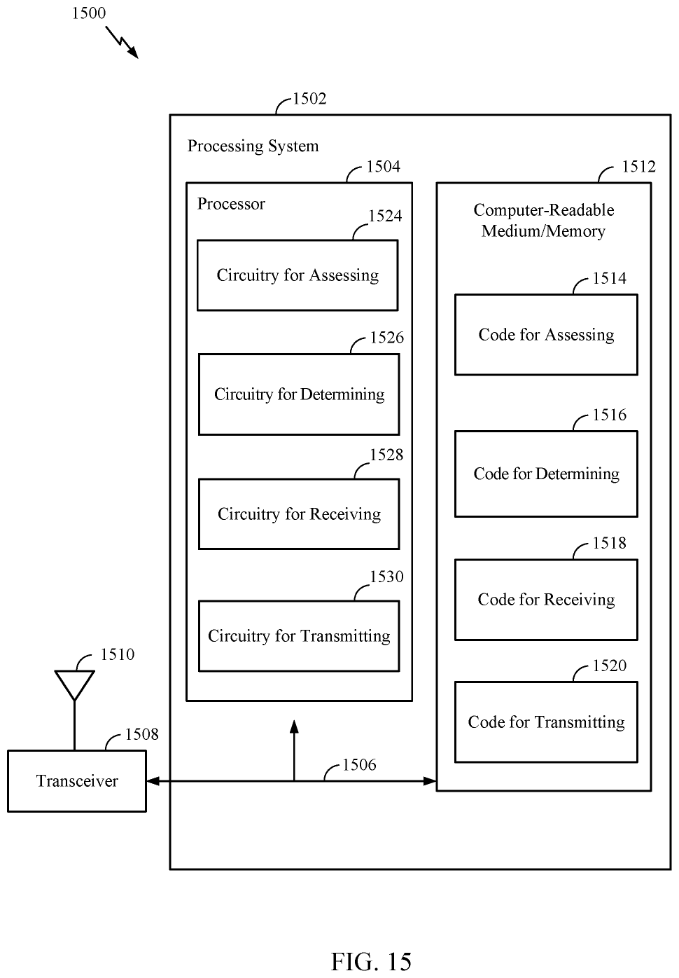

FIG. 15 illustrates a communications device 1500 that may include various components (e.g., corresponding to means-plus-function components) operable, configured, or adapted to perform operations for the techniques disclosed herein, such as the operations illustrated in FIG. 8.

Communications device 1500 includes a processing system 1502 coupled to a transceiver 1508 (e.g., a transmitter and/or a receiver). Transceiver 1508 is configured to transmit and receive signals for communications device 1500 via an antenna 1510, such as the various signals as described herein. Processing system 1502 may be configured to perform processing functions for communications device 1500, including processing signals received and/or to be transmitted by communications device 1500.

Processing system 1502 includes a processor 1504 coupled to a computer-readable medium/memory 1512 via a bus 1506. In certain aspects, computer-readable medium/memory 1512 is configured to store instructions (e.g., computer-executable code) that when executed by processor 1504, cause processor 1504 to perform the operations illustrated in FIG. 8, or other operations for performing the various techniques discussed herein for slot conversion.

In certain aspects, computer-readable medium/memory 1512 stores code 1514 (e.g., an example means for) for assessing (e.g., sensing or detecting an energy level); code 1516 (e.g., an example means for) for determining; code 1518 (e.g., an example means for) for receiving; and code 1520 (e.g., an example means for) for transmitting.

In certain aspects, code 1514 for assessing may include code for assessing expected interference from a second BS to uplink communications on at least a portion of a first slot, the at least the portion of the first slot being configured for downlink.

In certain aspects, code 1516 for determining may include code for determining whether to convert the configuration of the at least the portion of the first slot from the downlink to uplink based on the assessment of the expected interference. In certain aspects, code 1516 for determining may include code for determining the at least the portion of the second slot to be sensed based on the slot format pattern such that the sensing indicates the expected interference on the at least the portion of the first slot if the configuration of the at least the portion of the first slot is converted to uplink.

In certain aspects, code 1518 for receiving may include code for receiving signaling from a UE via the at least the portion of the first slot in accordance with the determination. In certain aspects, code 1518 for receiving may include code for receiving an indication of a slot format pattern configured at the second base station, wherein the assessment of the expected interference is based on the indication of the slot format pattern. In certain aspects, code 1518 for receiving may include code for receiving the results of the one or more measurements, wherein the assessing of the expected interference is based on the indication from the one or more UEs.

In certain aspects, code 1520 for transmitting may include code for transmitting, to one or more UEs, an indication to report results of one or more measurements performed on at least a portion of a second slot associated with the at least the portion of the first slot. In certain aspects, code 1520 for transmitting may include code for transmitting, to the UE, an indication that the at least the portion of the first slot has been converted from downlink to uplink.

In certain aspects, processor 1504 has circuitry configured to implement the code stored in computer-readable medium/memory 1512. Processor 1504 includes circuitry 1524 (e.g., an example means for) for assessing (e.g., sensing, or detecting an energy level); circuitry 1526 (e.g., an example means for) for determining; circuitry 1528 (e.g., an example means for) for receiving; and circuitry 1530 (e.g., an example means for) for transmitting.

In certain aspects, circuitry 1524 for assessing may include circuitry for assessing expected interference from a second BS to uplink communications on at least a portion of a first slot, the at least the portion of the first slot being configured for downlink.

In certain aspects, circuitry 1526 for determining may include circuitry for determining whether to convert the configuration of the at least the portion of the first slot from the downlink to uplink based on the assessment of the expected interference. In certain aspects, circuitry 1526 for determining may include circuitry for determining the at least the portion of the second slot to be sensed based on the slot format pattern such that the sensing indicates the expected interference on the at least the portion of the first slot if the configuration of the at least the portion of the first slot is converted to uplink.

In certain aspects, circuitry 1528 for receiving may include circuitry for receiving signaling from a UE via the at least the portion of the first slot in accordance with the determination. In certain aspects, circuitry 1528 for receiving may include circuitry for receiving an indication of a slot format pattern configured at the second base station, wherein the assessment of the expected interference is based on the indication of the slot format pattern. In certain aspects, circuitry 1528 for receiving may include circuitry for receiving the results of the one or more measurements, wherein the assessing of the expected interference is based on the indication from the one or more UEs.

In certain aspects, circuitry 1530 for transmitting may include circuitry for transmitting, to one or more UEs, an indication to report results of one or more measurements performed on at least a portion of a second slot associated with the at least the portion of the first slot. In certain aspects, circuitry 1530 for transmitting may include circuitry for transmitting, to the UE, an indication that the at least the portion of the first slot has been converted from downlink to uplink.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

Various components of communications device 1500 may provide means for performing the methods described herein, including with respect to FIG. 8.

In some examples, means for assessing and means for determining may include a processing system, which may include one or more processors, such as receive processor 238, transmit processor 220, TX MIMO processor 230, and/or controller/processor 240, including conversion manager 112, of BS 110a illustrated in FIG. 2 and/or processing system 1502 of communication device 1500 in FIG. 15.

In some examples, means for transmitting or sending (or means for outputting for transmission) may include transceivers 232 and/or antenna(s) 234 of BS 110a illustrated in FIG. 2 and/or transceiver 1508 and antenna 1510 of communications device 1500 in FIG. 15.

In some examples, means for receiving (or means for obtaining) may include transceivers 232 and/or antenna(s) 234 of BS 110a illustrated in FIG. 2 and/or transceiver 1508 and antenna 1510 of communications device 1500 in FIG. 15.

Notably, FIG. 15 is just a use example, and many other examples and configurations of communications device 1500 are possible.

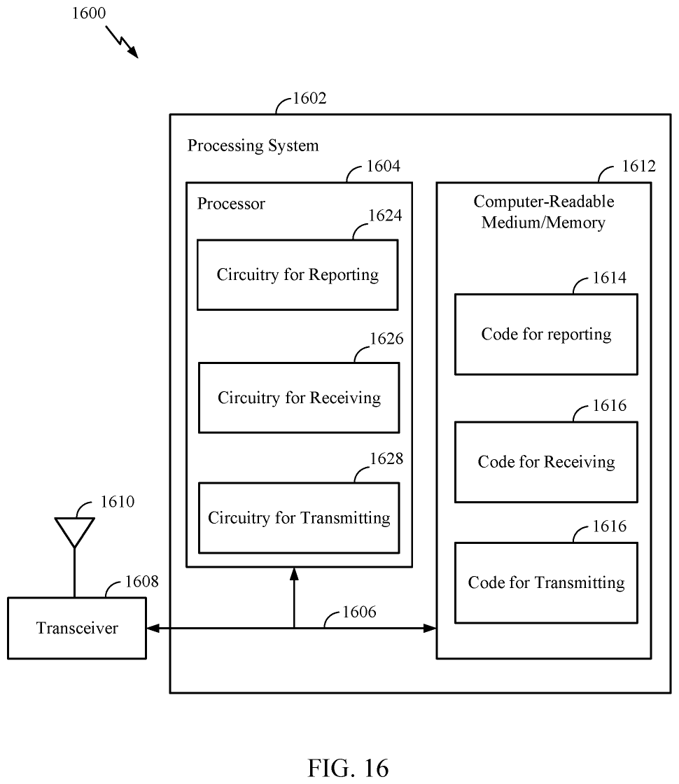

FIG. 16 illustrates a communications device 1600 that may include various components (e.g., corresponding to means-plus-function components) operable, configured, or adapted, to perform operations for the techniques disclosed herein, such as the operations illustrated in FIG. 12.

Communications device 1600 includes a processing system 1602 coupled to a transceiver 1608 (e.g., a transmitter and/or a receiver). Transceiver 1608 is configured to transmit and receive signals for communications device 1600 via an antenna 1610, such as the various signals as described herein. Processing system 1602 may be configured to perform processing functions for communications device 1600, including processing signals received and/or to be transmitted by communications device 1600.

Processing system 1602 includes a processor 1604 coupled to a computer-readable medium/memory 1612 via a bus 1606. In certain aspects, computer-readable medium/memory 1612 is configured to store instructions (e.g., computer-executable code) that when executed by processor 1604, cause processor 1604 to perform the operations illustrated in FIG. 12, or other operations for performing the various techniques discussed herein for slot conversion.

In certain aspects, computer-readable medium/memory 1612 stores code 1614 (e.g., an example means for) for reporting (e.g., performing one or more measurements and reporting results of the one or more measurements); code 1616 (e.g., an example means for) for receiving; and code 1618 (e.g., an example means for) for transmitting.

In certain aspects, code 1614 for reporting may include code for reporting the results of the one or more measurements to the BS.

In certain aspects, code 1616 for receiving may include code for receiving, from a BS, an indication to report results of one or more measurements on at least a portion of a first slot associated with at least the portion of a second slot configured for downlink. In certain aspects, code 1616 for receiving may include code for receiving, from the BS, an indication that the configuration of the at least the portion of the second slot is to be converted from the downlink to uplink based on the reporting of the results of the one or more measurements.

In certain aspects, code 1618 for transmitting may include code for transmitting signaling to the BS via the at least the portion of the second slot in accordance with the indication that the at least the portion of the second slot is to be converted.

In certain aspects, the processor 1604 has circuitry configured to implement the code stored in the computer-readable medium/memory 1612. Processor 1604 includes circuitry 1624 (e.g., an example means for) for reporting (e.g., performing one or more measurements and reporting results of the one or more measurements); circuitry 1626 (e.g., an example means for) for receiving; and circuitry 1628 (e.g., an example means for) for transmitting.

In certain aspects, circuitry 1624 for reporting may include circuitry for reporting the results of the one or more measurements to the BS.

In certain aspects, circuitry 1626 for receiving may include circuitry for receiving, from a BS, an indication to report results of one or more measurements on at least a portion of a first slot associated with at least the portion of a second slot configured for downlink. In certain aspects, circuitry 1626 for receiving may include circuitry for receiving, from the BS, an indication that the configuration of the at least the portion of the second slot is to be converted from the downlink to uplink based on the reporting of the results of the one or more measurements.

In certain aspects, circuitry 1628 for transmitting may include circuitry for transmitting signaling to the BS via the at least the portion of the second slot in accordance with the indication that the at least the portion of the second slot is to be converted.

Various components of communications device 1600 may provide means for performing the methods described herein, including with respect to FIG. 16.

In some examples, means for measuring and means for reporting may include a processing system, which may include one or more processors, such as receive processor 258, transmit processor 264, TX MIMO processor 266, and/or controller/processor 280, including power control component 281, of the UE 120a illustrated in FIG. 2 and/or processing system 1602 of communications device 1600 in FIG. 16.

In some examples, means for transmitting or sending (or means for outputting for transmission) may include transceivers 254 and/or antenna(s) 252 of UE 120a illustrated in FIG. 2 and/or transceiver 1608 and antenna 1610 of communications device 1600 in FIG. 16.

In some examples, means for receiving (or means for obtaining) may include transceivers 254 and/or antenna(s) 252 of UE 120a illustrated in FIG. 2 and/or transceiver 1608 and antenna 1610 of communications device 1600 in FIG. 16.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

Notably, FIG. 16 is just a use example, and many other examples and configurations of communications device 1600 are possible.

### EXAMPLE ASPECTS

Aspect 1. A method for wireless communication by a first base station, comprising: assessing expected interference from a second base station to uplink communications on at least a portion of a first slot, the at least the portion of the first slot being configured for downlink; determining whether to convert the configuration of the at least the portion of the first slot from the downlink to uplink based on the assessment of the expected interference; and receiving signaling from a user-equipment (UE) via the at least the portion of the first slot in accordance with the determination.

Aspect 2. The method of aspect 1, wherein the first base station and the second base station are associated with different operators.

Aspect 3. The method of aspect wherein the first base station and the second base station are associated with same operators.

Aspect 4. The method of any one of aspects 1-3, wherein the assessing of the expected interference comprises assessing whether at least a portion of a second slot is configured for downlink or uplink at the second base station.

Aspect 5. The method of aspect 4, wherein the first slot and the second slot are on full overlapping bands, partially overlapping bands, or adjacent bands.

Aspect 6. The method of any one of aspects 1-5, wherein the assessing of the expected interference comprises sensing at least a portion of a second slot associated with the at least the portion of the first slot.

Aspect 7. The method of aspect 6, wherein: the second slot is one of multiple slots associated with a slot format pattern configured at the second base station; and the method further comprises determining the at least the portion of the second slot to be sensed based on the slot format pattern such that the sensing indicates the expected interference on the at least the portion of the first slot if the configuration of the at least the portion of the first slot is converted to uplink.

Aspect 8. The method of any one of aspects 6-7, wherein the at least the portion of the first slot comprises a subset of symbols of the first slot.

Aspect 9. The method of any one of aspects 6-8, further comprising detecting whether an energy level associated with the sensing of the at least the portion of the second slot is greater than a threshold, wherein the assessment of expected interference is based on the detection.

Aspect 10. The method of any one of aspects 6-9, wherein the sensing of the at least the portion of the second slot is performed for one or more beams, the at least the portion of the first slot being converted to uplink for communication using at least one of the one or more beams.

Aspect 11. The method of any one of aspects 1-10, further comprising receiving an indication of a slot format pattern configured at the second base station, wherein the assessment of the expected interference is based on the indication of the slot format pattern.

Aspect 12. The method of aspect 11, wherein the indication is received from the second base station or a central unit.

Aspect 13. The method of any one of aspects 11-12, wherein the indication of the slot format pattern is received via a system information block (SIB).

Aspect 14. The method of any one of aspects 1-13, further comprising: transmitting, to one or more UEs, an indication to report results of one or more measurements performed on at least a portion of a second slot associated with the at least the portion of the first slot; and receiving the results of the one or more measurements, wherein the assessing of the expected interference is based on the indication from the one or more UEs.

Aspect 15. The method of aspect 14, wherein the results of the one or more measurements comprises: a reference signal received power (RSRP); a signal-to-interference-plus-noise ratio (SINR); a received signal strength indication (RSSI); sensed energy level; or any combination thereof.

Aspect 16. The method of any one of aspects 14-15, wherein the one or more measurements are performed on one or more beams.

Aspect 17. The method of any one of aspects 14-16, wherein the one or more measurements are performed on one or more subbands.

Aspect 18. The method of any one of aspects 1-17, wherein determining whether to convert comprises determining whether to convert the configuration of the first slot from downlink only to full duplex slot with simultaneous uplink and downlink operation within the component carrier bandwidth.

Aspect 19. The method of aspect 18, wherein the full duplex comprises int-band full duplex (IBFD) or sub-band full duplex (SBFD).

Aspect 20. The method of any one of aspects 1-19, further comprising transmitting, to the UE, an indication that the at least the portion of the first slot has been converted from downlink to uplink.

Aspect 21. The method of any one of aspects 1-20, wherein the at least the portion of the first slot comprises one or more sub-bands of a component carrier for the first slot.

Aspect 22. A method for wireless communication by a userequipment (UE), comprising: receiving, from a base station, an indication to report results of one or more measurements on at least a portion of a first slot associated with at least the portion of a second slot configured for downlink; reporting the results of the one or more measurements to the base station; receiving, from the base station, an indication that the configuration of the at least the portion of the second slot is to be converted from the downlink to uplink based on the reporting of the results of the one or more measurements; and transmitting signaling to the base station via the at least the portion of the second slot in accordance with the indication that the at least the portion of the second slot is to be converted.

Aspect 23. The method of aspect 22, wherein the results of the one or more measurements comprises: a reference signal received power (RSRP); a signal-to-interference-plus-noise ratio (SINR); a received signal strength indication (RSSI); sensed energy level; or any combination thereof.

Aspect 24. The method of any one of aspects 22-23, wherein the at least the portion of the second slot comprises a subset of symbols of the second slot.

Aspect 25. The method of any one of aspects 22-24, wherein the at least the portion of the second slot comprises one or more sub-bands of a component carrier for the second slot.

Aspect 26. The method of any one of aspects 22-25, wherein the at least the portion of the first slot comprises a subset of symbols of the second slot.

Aspect 27. The method of any one of aspects 22-26, wherein the at least the portion of the first slot comprises one or more sub-bands of a component carrier for the second slot.

Aspect 28. The method of any one of aspects 22-27, wherein the one or more measurements are performed for one or more beams, and wherein the at least the portion of the second slot being converted to uplink is for communication using at least one of the one or more beams.

Aspect 29. The method of any one of aspects 22-28, wherein the indication that the configuration is to be converted comprises an indication that the second slot is to be converted from downlink only to full duplex slot with simultaneous uplink and downlink operation within the component carrier bandwidth.

Aspect 30. The method of aspect 29, wherein the full duplex comprises int-band full duplex (IBFD) or sub-band full duplex (SBFD).

Aspect 31. An apparatus comprising means for performing the method of any of aspects 1 through 30.

Aspect 32. An apparatus comprising at least one processor and a memory coupled to the at least one processor, the memory comprising code executable by the at least one processor to cause the apparatus to perform the method of any of aspects 1 through 30.

Aspect 33. A computer-readable medium storing computer executable code thereon for wireless communications that, when executed by at least one processor, cause an apparatus to perform the method of any of aspects 1 through 30.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 8 and 12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication by a first base station, comprising:
a memory; and
one or more processors coupled to the memory, the memory and the one or more processors being configured to:
assess expected interference from a second base station (BS) to uplink communications on at least a portion of a first slot, the at least the portion of the first slot being configured for downlink;
determine whether to convert the configuration of the at least the portion of the first slot from the downlink to uplink based on the assessment of the expected interference; and
receive signaling from a user equipment (UE) via the at least the portion of the first slot in accordance with the determination.

2. The apparatus of claim 1, wherein:
the first BS and the second BS are associated with different operators.

3. The apparatus of claim 1, wherein:
the first BS and the second BS are associated with same operators.

4. The apparatus of claim 1, wherein the memory and the one or more processors being configured to assess the expected interference comprises the memory and the one or more processors being configured to assess whether at least a portion of a second slot is configured for downlink or uplink at the second BS.

5. The apparatus of claim 4, wherein the first slot and the second slot are on full overlapping bands, partially overlapping bands, or adjacent bands.

6. The apparatus of claim 1, wherein the memory and the one or more processors being configured to assess the expected interference comprises the memory and the one or more processors being configured to sense at least a portion of a second slot associated with the at least the portion of the first slot.

7. The apparatus of claim 6, wherein:
the second slot is one of multiple slots associated with a slot format pattern configured at the second BS; and
wherein the memory and the one or more processors are further configured to determine the at least the portion of the second slot to be sensed based on the slot format pattern such that the sensing indicates the expected interference on the at least the portion of the first slot if the configuration of the at least the portion of the first slot is converted to uplink.

8. The apparatus of claim 6, wherein the at least the portion of the first slot comprises a subset of symbols of the first slot.

9. The apparatus of claim 6, the memory and the one or more processors are further configured to detect whether an energy level associated with the sensing of the at least the portion of the second slot is greater than a threshold, wherein the assessing of the expected interference is based on the detection.

10. The apparatus of claim 6, wherein the sensing of the at least the portion of the second slot is performed for one or more beams, the at least the portion of the first slot being converted to uplink for communication using at least one of the one or more beams.

11. The apparatus of claim 1, wherein the memory and the one or more processors are further configured to receive an indication of a slot format pattern configured at the second BS, wherein the assessment of the expected interference is based on the indication of the slot format pattern.

12. The apparatus of claim 11, wherein the indication is received from the second BS or a central unit.

13. The apparatus of claim 11, wherein the indication of the slot format pattern is received via a system information block (SIB).

14. The apparatus of claim 1, wherein the memory and the one or more processors are further configured to:
transmit, to one or more UEs, an indication to report results of one or more measurements performed on at least a portion of a second slot associated with the at least the portion of the first slot; and
receive the results of the one or more measurements, wherein the assessing of the expected interference is based on the indication from the one or more UEs, wherein the results of the one or more measurements comprises:
a reference signal received power (RSRP);
a signal-to-interference-plus-noise ratio (SINR);
a received signal strength indication (RSSI);
sensed energy level; or
any combination thereof.

15. The apparatus of claim 14, wherein the one or more measurements are performed on one or more beams.

16. The apparatus of claim 14, wherein the one or more measurements are performed on one or more subbands.

17. The apparatus of claim 1, wherein the memory and the one or more processors being configured to determine whether to convert comprises the memory and the one or more processors being configured to determine whether to convert the configuration of the first slot from downlink only to full duplex slot with simultaneous uplink and downlink operation within a component carrier bandwidth.

18. The apparatus of claim 17, wherein the full duplex comprises in-band full duplex (IBFD) or sub-band full duplex (SBFD).

19. The apparatus of claim 1, wherein the memory and the one or more processors are further configured to transmit, to the UE, an indication that the at least the portion of the first slot has been converted from downlink to uplink.

20. The apparatus of claim 1, wherein the at least the portion of the first slot comprises one or more sub-bands of a component carrier for the first slot.

21. An apparatus, comprising:
a memory; and
one or more processors coupled to the memory, the memory and the one or more processors being configured to:
receive, from a base station (BS), an indication to report results of one or more measurements on at least a portion of a first slot associated with at least the portion of a second slot configured for downlink;
report the results of the one or more measurements to the BS;
receive, from the BS, an indication that the configuration of the at least the portion of the second slot is to be converted from the downlink to uplink based on the reporting of the results of the one or more measurements; and
transmit signaling to the BS via the at least the portion of the second slot in accordance with the indication that the at least the portion of the second slot is to be converted.

22. The apparatus of claim 21, wherein the results of the one or more measurements comprises:
a reference signal received power (RSRP);
a signal-to-interference-plus-noise ratio (SINR);
a received signal strength indication (RSSI);
sensed energy level; or
any combination thereof.

23. The apparatus of claim 21, wherein the at least the portion of the second slot comprises a subset of symbols of the second slot.

24. The apparatus of claim 21, wherein the at least the portion of the second slot comprises one or more sub-bands of a component carrier for the second slot.

25. The apparatus of claim 21, wherein the at least the portion of the first slot comprises a subset of symbols of the second slot.

26. The apparatus of claim 21, wherein the at least the portion of the first slot comprises one or more sub-bands of a component carrier for the second slot.

27. The apparatus of claim 21, wherein the one or more measurements are performed for one or more beams, and wherein the at least the portion of the second slot being converted to uplink is for communication using at least one of the one or more beams.

28. The apparatus of claim 21, wherein the indication that the configuration is to be converted comprises an indication that the second slot is to be converted from downlink only to full duplex slot with simultaneous uplink and downlink operation within a component carrier bandwidth.

29. A method for wireless communication by a first base station (BS), comprising:
assessing expected interference from a second BS to uplink communications on at least a portion of a first slot, the at least the portion of the first slot being configured for downlink;
determining whether to convert the configuration of the at least the portion of the first slot from the downlink to uplink based on the assessment of the expected interference; and
receiving signaling from a user equipment (UE) via the at least the portion of the first slot in accordance with the determination.

30. A method for wireless communication by a user equipment (UE), comprising:
receiving, from a base station (BS), an indication to report results of one or more measurements on at least a portion of a first slot associated with at least the portion of a second slot configured for downlink;
reporting the results of the one or more measurements to the BS;
receiving, from the BS, an indication that the configuration of the at least the portion of the second slot is to be converted from the downlink to uplink based on the reporting of the results of the one or more measurements; and
transmitting signaling to the BS via the at least the portion of the second slot in accordance with the indication that the at least the portion of the second slot is to be converted.
